(19) United States
(12) Patent Application Publication
(10) Pub. No.: US 2026/0225495 A1
(43) Pub. Date: Aug. 6, 2026

(54) THERMAL MANAGEMENT SYSTEM FOR A VEHICLE

(71) Applicant: Torc Robotics, Inc., Blacksburg, VA (US)

(72) Inventors: Simon Baeuerle, Kassel (DE); Margarita Kunjavskaja, Gerlingen (DE); Maximilian Koeper, Ostfidern (DE); Marat Kopytjuk, Heilbronn (DE); Maximilian Yassine Beyen, Leutenbach (DE)

(21) Appl. No.: 19/047,025

(22) Filed: Feb. 6, 2025

(51) Int. Cl. B60L 58/27; B60L 3/12

(52) U.S. Cl. CPC B60L 58/27; B60L 3/12; B60L 2240/545; B60L 2240/662

(57) ABSTRACT

A thermal management system for a vehicle is provided. The system includes sensors measuring a heat flux and/or temperature of a first group of components of the vehicle, with at least one component of the first group of components generating heat. The system includes sensors measuring a heat flux and/or a temperature of a second group of components of the vehicle. The system includes a thermal system interconnected between the groups of components. A processing device acquires sensor data from the sensors indicative of the heat flux and/or temperature of the first group of components of the vehicle, and acquires sensor data from the sensors indicative of the heat flux and/or the temperature of the second group of components of the vehicle. Based on the sensor data, the processing device determines how the heat generated by the at least one component of the first group of components should be treated.

### TECHNICAL FIELD

The field of the disclosure relates to a thermal management system and, in particular, to a system for monitoring vehicle component temperatures and determining how generated heat from the components should be treated for efficient operation of the components.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

Vehicles have a variety of components that are essential to the proper and efficient operation of the vehicle. In addition to traditional components, electric vehicles include a battery pack that necessitates efficient thermal management for cooling or heating during usage and/or charging depending on ambient temperatures and during usage of the vehicle. The heat generated by components of the vehicle is generally vented to the surrounding environment without considering how the generated heat could be alternatively used for thermal management of other components of the vehicle.

Accordingly, there exists a need for a system and a method of thermal management for a vehicle to efficiently manage heating and/or cooling of various components, and distributing or using generated heat in an effective manner. These and other needs are met by the exemplary system for thermal management for a vehicle discussed herein.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, an exemplary thermal management system for a vehicle is provided. The system includes a first set of one or more sensors configured to measure at least one of a heat flux or temperature of a first group of components of the vehicle. At least one component of the first group of components generates heat. The system includes a second set of one or more sensors configured to measure at least one of a heat flux or a temperature of a second group of components of the vehicle. In some embodiments, the system can measure the heat flux and/or the temperature for one or both of the first and second groups of components. The system includes a thermal system or unit interconnected between the first and the second groups of components. The system includes a processing device in communication with the first and the second sets of the one or more sensors and the thermal system. The processing device is configured to execute instructions stored in a memory to perform operations that include acquiring sensor data from the first set of the one or more sensors indicative of the heat flux and/or the temperature of the first group of components of the vehicle, and acquiring sensor data from the second set of the one or more sensors indicative of the heat flux and/or the temperature of the second group of components of the vehicle. Based on the sensor data from the first and second sets of the one or more sensors, the operations include determining if the heat generated by the at least one component of the first group of components should be (i) transferred via the thermal system to provide directed heating to at least one component of the second group of components, (ii) transformed into usable electric energy, and/or (iii) dissipated into an environment around the vehicle. In some embodiments, a thermal model of all components can be executed by the processing unit to approximate the current temperature in the respective components.

In some embodiments, the vehicle can be, e.g., an autonomous vehicle, a semi-autonomous vehicle, a non-autonomous vehicle, or the like. In some embodiments, the first group of components can include pure heat sources, e.g., a computing device, a motor, a gearbox, a cooled trailer, or combinations thereof. In some embodiments, the first group of components and the second group of components can include mixed heat source/sink sources, e.g., a battery, a sensor, a vehicle cabin, a trailer, or combinations thereof. For example, the vehicle cabin of a semi or non-autonomous vehicle where a human is inside or a trailer that must be kept at a substantially constant temperature can be a mixed heat source/sink source. In some embodiments, the first group of components can include passive components in the form of a pure heat source, a mixed heat/sink source, and/or a pure heat sink.

In some embodiments, the second group of components can include active components in the form of energy increasing components, energy decreasing components, and/or heat exchanging components. The system can include a heat source, and the operations can include selectively generating and supplying heat from the heat source to the first and/or second group of components from the heat source. The system can include a thermoelectric generator configured to transform the heat generated by the at least one component of the first group of components into the usable electric energy. The system can include an energy storage configured to store the usable electric energy generated by the thermoelectric generator.

In some embodiments, the operations can include analyzing a planned route for the vehicle and determining if the heat generated by the at least one component of the first group of components should be (i) transferred via the thermal system to provide the directed heating to at least one component of the second group of components, (ii) transformed into the usable electric energy, and/or (iii) dissipated into the environment around the vehicle, based on the planned route. In some embodiments, the operations can include weighing which components of the second group of components necessitate transfer of the heat via the thermal system.

In some embodiments, the system can include an environment sensor configured to measure a temperature in the environment around the vehicle. In some embodiments, the at least one component of the second group can be a battery, and the operations can include transferring via the thermal system the heat generated by the at least one component of the first group of components to warm the battery when the temperature in the environment is measured to be below a threshold value during starting of the vehicle. In some embodiments, the operations can include, after a predetermined time after starting of the vehicle, removing the heat generated by the at least one component of the first group of components from the battery. In some embodiments, the operations can include determining the time of day, which can be important for optimization of the thermal management system (e.g., greater cooling needed during the day as compared to nighttime).

In another aspect, an exemplary computer-implemented method for thermal management of a vehicle is provided. The method includes acquiring sensor data from a first set of one or more sensors indicative of at least one of a heat flux or a temperature of a first group of components of the vehicle, and acquiring sensor data from a second set of the one or more sensors indicative of at least one of a heat flux or a temperature of a second group of components of the vehicle. The method includes executing instructions stored in a memory with a processing device in communication with the first and second sets of the one or more sensors, and a thermal system interconnected between the first and second groups of components, to perform operations for thermal management. The operations include, based on the sensor data from the first and second sets of the one or more sensors, determining if the heat generated by the at least one component of the first group of components should be (i) transferred via the thermal system to provide directed heating to at least one component of the second group of components, (ii) transformed into usable electric energy, and/or (iii) dissipated into an environment around the vehicle.

In some embodiments, the first group of components can include passive components in the form of a pure heat source, a mixed heat/sink source, and/or a pure heat sink. In some embodiments, the operations can include selectively generating and supplying heat from the heat source to the first and/or second group of components from a heat source.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic perspective view of an autonomous truck.

FIG. 2 is a schematic perspective view of an autonomous truck and trailer.

FIG. 3 is a schematic side view of an autonomous truck and trailer.

FIG. 4 is a block diagram of the autonomous truck shown in FIGS. 1-3.

FIG. 5 is a block diagram of an example computing system.

FIG. 6 is a block diagram of an exemplary system for thermal management of a vehicle.

FIG. 7 is a flowchart of a method for thermal management of a vehicle.

FIG. 8 is a block diagram of an exemplary system for thermal management of a vehicle, including passive and active components and the communication therebetween.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

Vehicles, including autonomous, semi-autonomous, and non-autonomous, generally necessitate an efficient thermal management system for cooling and heating of various components, such as (but not limited to) computing devices, a combustion engine, an electric engine, a hydrogen/methane fuel cell, sensors (LiDAR, radar, cameras, or the like), a battery pack, combinations thereof, or the like. For electric vehicles, the battery pack may need particularly efficient thermal management for cooling or heating during usage/charging, whether the energy needed for vehicle motion is stored in a battery or within hydrogen/methane. Heating of the battery pack may be needed during cold ambient temperatures and/or during an initial period of time after starting the vehicle.

Although applicable to all types of vehicles, autonomous vehicles generally include a larger number of computing devices that necessitate thermal management. These computing devices can produce larger amounts of latent heat, e.g., a range of about 2-8 kW inclusive, or the like. The exemplary thermal management system integrates the computing devices as a heat source into the integral heat management operation. Within the exemplary system, several heat sources (such as computing devices, the battery pack during discharge/charging, an internal combustion engine, or the like) are combined and the system autonomously and automatically determines whether the state of the generated heat should be maintained (heat is used to warm other components), the state of the heat should be changed (into electric energy by a thermoelectric generator), and/or heat should be dissipated into the surrounding environment (venting).

The exemplary system therefore balances the heat generation from components of the system and distributes or uses the heat appropriately to manage the thermal balance of components of the system. The exemplary system can further analyze the planned route of the vehicle to estimate how components will generate heat and/or if additional heating or cooling will be needed to optimize operation of the components.

The exemplary system differentiates between an energy transfer system, and active as well as passive components. The energy transfer system (ETS) (i.e., thermal system or unit) connects all components and transfers energy between them. The conducting matter can be either a fluid (e.g., gas and/or liquid) or a solid to transfer energy via energy pipes. The ETS includes blocks distributing the conducting matter, thereby acting as a valve system. The distribution blocks can be computer or processing device controlled based on data from sensors placed throughout the system.

Passive components can include, but are not limited to, e.g., pure heat sources (only need cooling, such as combustion/electric engine, computing device, or the like), pure heat sinks (only need heating, such as a heated trailer, or the like), and/or mixed heat sources/sinks (need temperature control, such as sensors, battery pack, hydrogen/methane fuel cell, or the like).

Active components can include, but are not limited to, e.g., energy increasing components (electric heater, solar-thermic components, heat pump, or the like), energy decreasing components (heat pump, radiator/dissipate to surrounding, thermoelectric generator, Stirling motor, or the like), and/or heat exchanging components (exchanging energy between the ETSs, such as a heat exchanger, or the like).

The ETS of the pure heat sources connects first the heat exchanger and then, if necessary, the energy decreasing components. Vice versa, the ETS of the pure heat sinks connects first the heat exchanger and then, if necessary, the energy increasing device. The ETS of the mixed heat sources/sinks either first connects to the heat exchanger or the energy decreasing/increasing devices. If first connected to the heat exchanger, the ETS can then connect either energy decreasing or increasing devices. For these tasks, all ETSs and components are equipped with sensors measuring the energy transport and temperature.

The control of the exemplary system can be carried out by a computing unit, e.g., a central computing/processing unit, distributed computing/processing units, or the like. The system can take into account planned routes for the vehicle, with estimates of the heat to be generated and/or heating/cooling for components that will be needed during the planned route. Historical data can be used to train the machine learning algorithm of the system to optimize the estimations for heating/cooling needed during the planned route. Multiple sensors of varying types can be used to monitor the system operation, and the acquired data can be stored or transferred for online or future evaluation. Because some vehicles may be used on predetermined or reoccurring routes, the energy consumption can be optimized based on the previously acquired data of the routes. The system therefore integrates the latent heat of various components of the vehicle into a general purpose thermal-management system, where the heat can be used for multiple purposes to optimize overall operation of the vehicle.

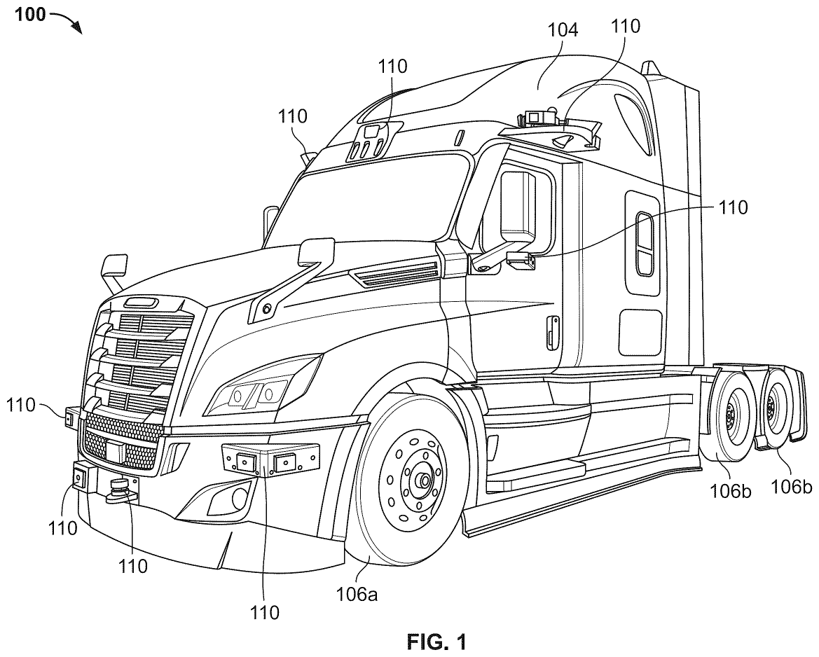

Various embodiments in the present disclosure are described with reference to FIGS. 1-8 below.

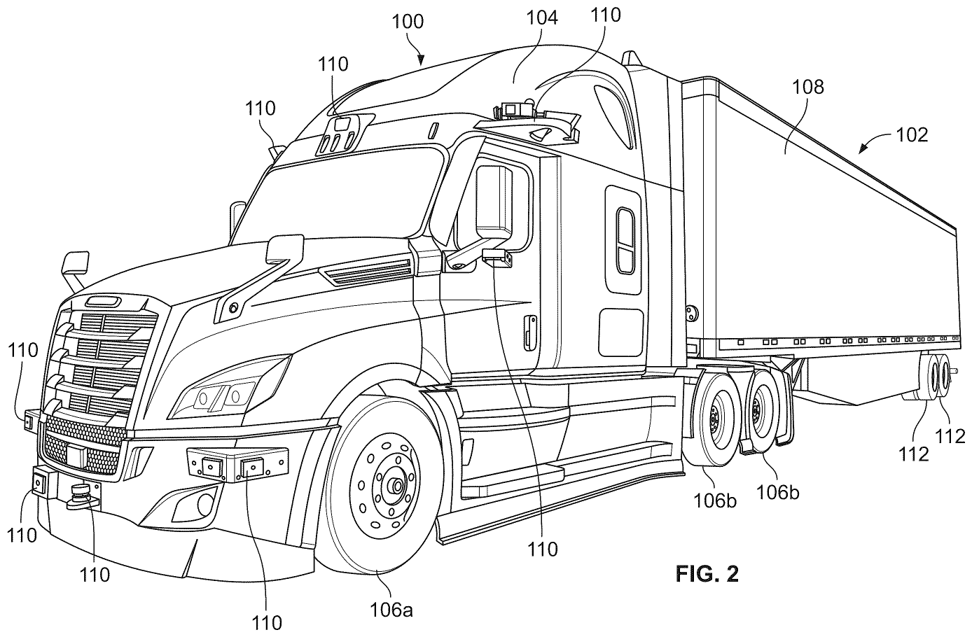

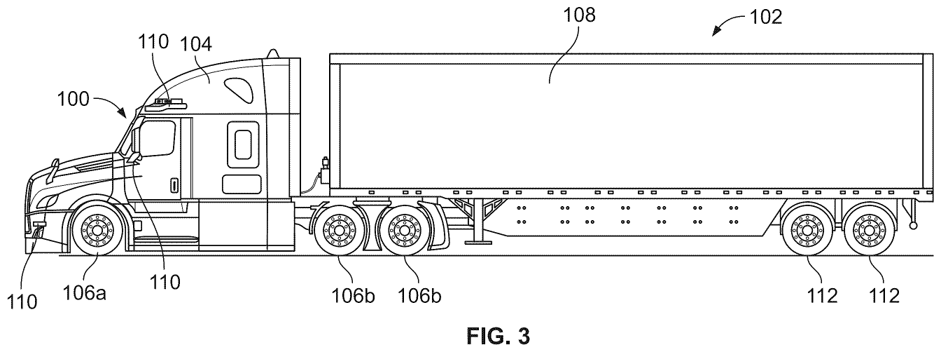

FIG. 1 is a perspective view of a vehicle 100, such as a truck that may be conventionally connected to a single or tandem trailer 102 to transport the trailer 102 to a desired location, as shown in FIGS. 2 and 3, which are, respectively, perspective and side views of the vehicle 100 of FIG. 1 with the trailer 102 attached thereto. The vehicle 100 includes a cabin 104 that can be supported, and steered in the required direction, by front wheels 106a and rear wheels 106b that are partially shown in FIG. 1. The front wheels 106a are positioned by a steering system that includes a steering wheel and a steering column (not shown). The steering wheel and the steering column may be located in the interior of cabin 104.

The vehicle 100 may be an autonomous vehicle, in which case the vehicle 100 may omit the steering wheel and the steering column to steer the vehicle 100. Rather, the vehicle 100 may be operated by an autonomy computing system of the vehicle 100 based on data collected by a sensor network including one or more sensors, e.g., sensors 110 shown in FIGS. 1-3. The vehicle 100 may additionally include a fifth-wheel coupling (not shown) to which the trailer 102 can be releasably attached. The trailer 102 can include a storage container 108 and a plurality of rear wheels 112 that support the storage container 108. It should be understood that in some embodiments the vehicle 100 and the trailer 102 can be a permanently attached as a single unit.

The sensors 110 have a field-of-view at the front, sides and/or rear of the vehicle 100. Similar sensors 110 can be used around the perimeter of the vehicle 100 to ensure full environmental coverage around the vehicle 100 is provided by the sensors 110. In some embodiments, the vehicle 100 can include, e.g., 5-6 LIDAR sensors, 8-10 cameras, combinations thereof, or the like. In some embodiments, the vehicle 100 can tow a trailer 102 and the trailer 102 can similarly include LIDAR sensors and/or cameras to provide field-of-view coverage around the perimeter of the vehicle 100 and the trailer 102. The environmental coverage by the sensors and/or cameras therefore provides data corresponding with the front, rear, sides and corners of the vehicle 100 and the trailer 102 hauled by the vehicle 100.

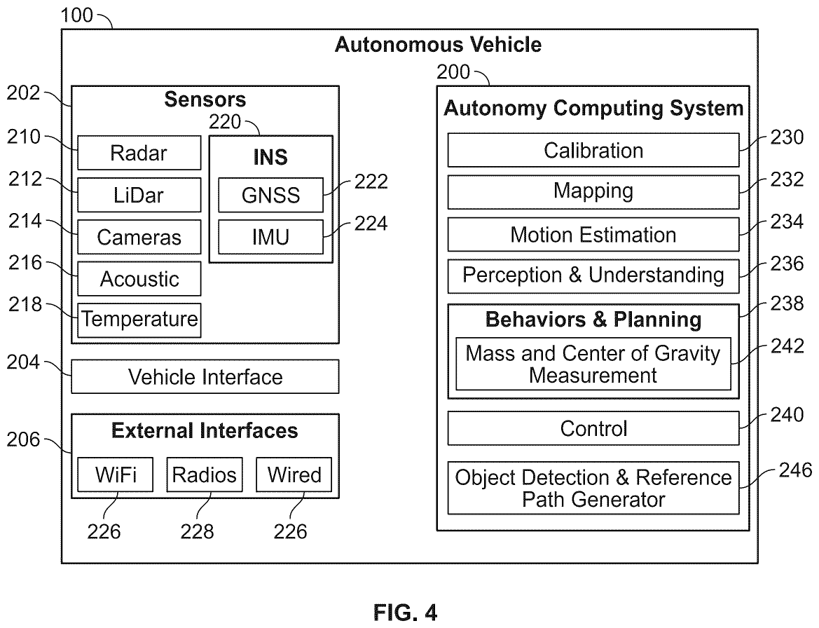

FIG. 4 is a block diagram representing autonomous vehicle 100 shown in FIGS. 1-3. In the example embodiment, autonomous vehicle 100 generally includes autonomy computing system 200, sensors 202, a vehicle interface 204, and external interfaces 206. It should be understood that the sensors 110 on the vehicle 100 in FIGS. 1-3 and described herein correspond to the sensors identified as 202 in FIG. 4. The sensors 110 may specifically comprise any of the sensors 210-220 shown in FIG. 4 and described herein.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying objects around the vehicle 100, updating a reference path based on the detected objects, and controlling operation of the vehicle 100 to guide the vehicle 100 along its route.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100. In some embodiments, the trailer associated with the vehicle 100 can include similar sensors 202 for gathering similar data associated with the trailer, thereby further assisting with control operations of the autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 226, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a mass and center of gravity measurement module 242, a control module or controller 240, and an object detection and reference path generator module 246. The object detection and reference path generator module 246, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

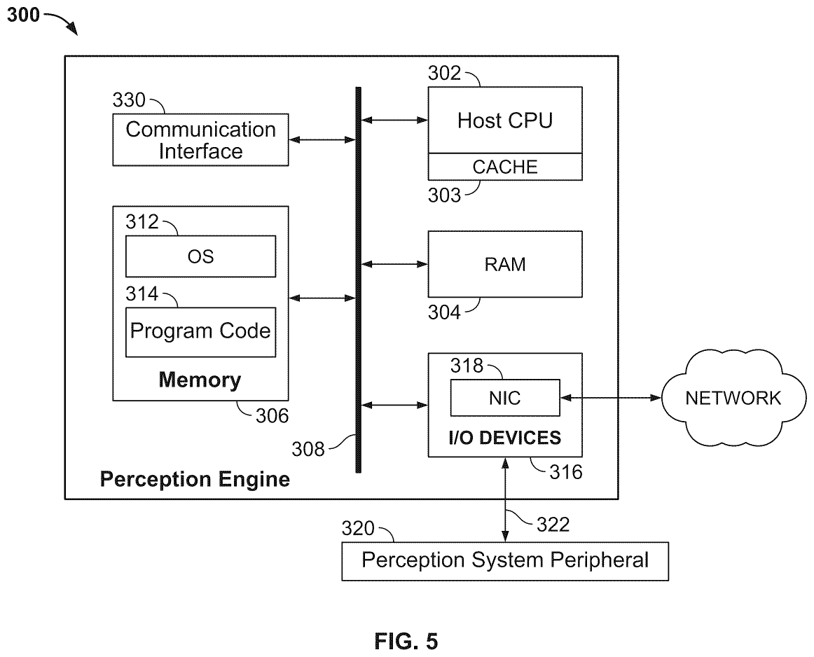

FIG. 5 is a block diagram of an example computing system 300, such as the autonomy computing system 200 shown in FIG. 4, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 4. In alternative embodiments, one or more sections of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

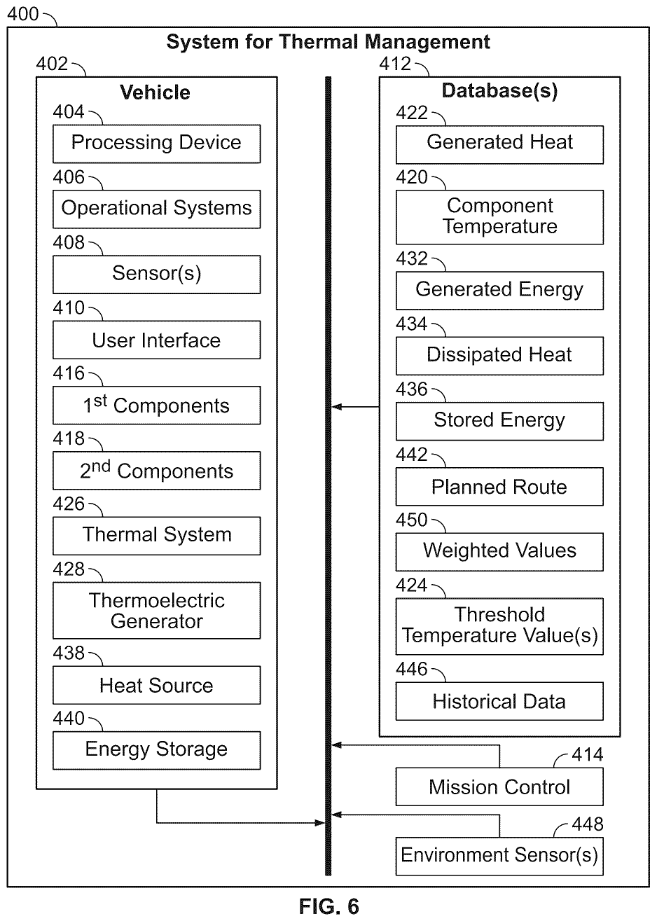

FIG. 6 is a block diagram of an exemplary system 400 for thermal management of a vehicle. The system 400 generally includes one or more vehicles 402 (e.g., autonomous vehicle 100, semi-autonomous vehicle, and/or non-autonomous vehicle). The vehicle 402 includes a processing device 404 (e.g., computing system 200, computing system 300, or the like) configured to receive and process data for monitoring temperatures and distributing/using generated heat to manage the thermal status of various components of the vehicle 402. The vehicle 402 can include one or more operational systems 406 (e.g., mapping 232, motion estimation 234, perception and understanding 236, behaviors and planning 242, control 240, object detection and reference path generator 246, combinations thereof, or the like) for operating the vehicle 402 within an environment.

The vehicle 402 can include one or more sensors 408 (e.g., sensors 202) for detecting the environment and objects within the environment around the vehicle 402. The sensors 408 can be used to monitor the temperature of various components for the vehicle 402 to determine actions to be taken for distribution and/or use of heat generated by components of the vehicle 402. In some embodiments, the sensors 408 can measure the heat flux and/or the temperature for the components of the vehicle 402. Thus, any reference to measuring temperature can include measurement of one or both of the temperature and/or heat flux of the component. In some embodiments, the temperature sensors can be dedicated to the respective components of the vehicle 402. In some embodiment, the sensors can monitor the temperature for one or more components of the vehicle 402.

The vehicle 402 includes a user interface 410 (e.g., vehicle interface 204) configured to receive/transmit and display data for operation of the system 400, as well as the vehicle 402 itself. The vehicle 402 can include one or more databases 412 (e.g., memory 306) configured to receive and electronically store data. In some embodiments, the database 412 can be stored externally from the vehicle 402 and the vehicle 402 can be in communication with the external database 412 for receiving and/or transmitting data associated with the system 400. In some embodiments, the database 412 can be located at mission control 414 (or at any other external location proximate a control unit) external to the vehicle 402 and in communication with the vehicle 402. In some embodiments, the database 412 can be located on the vehicle 402 itself. In some embodiments, one or more portions of the database 412 can be distributed across components of the system 400. The database 412 can store information relating to thermal management of the components of the vehicle 402.

The vehicle 402 includes a variety of components, generally grouped here as first and second components 416, 418. However, it should be understood that more than two groups could be used for designating the components. The first components 416 can include, e.g., pure heat sources (such as a computing device and/or a motor), or the like. In some embodiments, the first components 416 can include passive components in the form of, e.g., pure heat sources, mixed heat/sink sources, and/or a pure heat sink. The second components 416 can include, e.g., mixed heat/sink sources, or the like. In some embodiments, the second components 416 can include, e.g., active components in the form of, e.g., energy increasing components, energy decreasing components, and/or heat exchanging components.

Passive components can include, e.g., pure heat sources, pure heat sinks, and/or mixed heat sources/sinks. The pure heat sources necessitate only cooling and can include, e.g., combustion or electric engines, computing devices, or the like. The pure heat sinks necessitate only heating and can include, e.g., a heated trailer, or the like. The mixed heat sources/sinks necessitate temperature control and can include, e.g., sensors, battery pack, hydrogen/methane fuel cell, or the like.

The temperature control for the mixed heat sources/sinks can vary depending on the specific detected temperature for the associated component and/or the environment/ambient temperature. Some components may need to be heated during driving, while others may need to be cooled. For example, a battery pack may need to be initially heated if the ambient temperature is cold to assist with starting of the vehicle. However, after an initial period of time for use of the vehicle, the battery pack can be cooled. In some instances, the battery pack may need to be cooled after charging. The exemplary thermal management system 400 discussed herein does not directly control the temperatures of the passive components; instead, the system 400 monitors the temperature of the passive components and uses the heat generated by the active components to appropriately and indirectly manage/maintain the temperature of the passive components, i.e., heat generated by other components are used to manage/maintain the temperature of the passive components.

Active components can include, energy increasing components, energy decreasing components, and/or heat exchanging components. The energy increasing components can include, e.g., an electric heater, solar-thermic components, a heat pump, or the like. The energy decreasing components can include, e.g., a heat pump, a radiator/dissipate to surrounding, a thermoelectric generator, a Stirling motor, or the like. The heat exchanging components can include, e.g., exchanging energy between the ETSs, such as a heat exchanger, or the like.

The exemplary thermal management system 400 discussed herein controls the active components and distributes/uses the heat generated by the active components to maintain the optimal temperature of the passive components. Energy pipes can be used to perform the heat transfer/exchange between components of the vehicle 402. Distribution blocks can be used with the energy pipes to assist with the heat transfer/exchange between components. The distribution blocks can function as valves, and can be in communication with a central controller, e.g., processing device 404, which activates the distribution blocks as needed for directing heating and/or cooling as needed.

As an example, the battery pack needs to be warmed and brought to a certain temperature during starting of the vehicle 402 and during initial operation of the vehicle 402. Heating fluid can be pumped to the battery pack via energy pipes to heat the battery pack, and via the energy pipes the fluid is pumped from the battery pack at a lower fluid temperature than the fluid temperature when the fluid was pumped into the battery pack. The controller determines where to pump the fluid and from which component. The heat exchanger can include temperature sensors to determine the temperature of the fluid as it moves through the system 400.

As another example, during charging of the battery pack, battery pack cooling may need to be performed. Cooling fluid can be pumped to the battery pack via energy pipes and as a result, the cooling fluid can leave the battery pack at a fluid temperature that is higher than the cooling fluid temperature when the cooling fluid entered or passed near the battery pack. The relatively warmer exiting cooling fluid can be used to heat other components that require heating.

As another example, in the case of an autonomous vehicle, the autonomy computing device (e.g., processing device) can be cooled to keep it from overheating. Cooling fluid can be pumped to the cooling system of the computing device via energy pipes and, as a result, the cooling fluid can leave the computing device at a fluid temperature that is higher than the cooling fluid temperature when the cooling fluid entered or passed near the computing device. The relatively warmer exiting cooling fluid can be used to heat other components that require heating.

As another example, a thermoelectric generator can be used to transform the energy contained in a heated cooling fluid to electric energy. The cooling fluid can be pumped into the generator, at least some of the thermal energy is converted, and the cooling fluid leaves the generator at a lower temperature than when it entered or passed near the thermoelectric generator.

In operation, the sensors 408 of the vehicle 402 are used to measure the temperature (e.g., temperature and/or heat flux) of the components 416, 418 in real-time or substantially real-time, and the temperature data can be electronically stored as component temperatures 420 in the database 412. In some embodiments, one of the sensors 408 can be dedicated to measuring the temperature of an associated component 416, 418. In some embodiments, a single sensor 408 can measure the temperature of multiple components 416, 418. In some embodiments, one or more of the sensors 408 can be used to detect and measure the generated heat 422 from one or more components 416, 418. The database 412 can receive as input and electronically store threshold temperature values 424 which can be, e.g., industry or manufacturer standards for temperature levels at which the components 416, 418 should be maintained during operation and/or storage.

The processing device 404 of the vehicle 402 receives as input at least the component temperatures 420 and the threshold temperature values 424 from the sensors 408 (and/or the processing device 404) to determine what action is needed (if any) for thermal management of the components 416, 418. The vehicle 402 includes a thermal system 426 (e.g., a thermal unit or the like) interconnected between the components 416, 418, and/or in communication with energy pipes/lines and/or distribution blocks/valves for regulation of thermal management of the components 416, 418. The processing device 404 is in communication with the thermal system 426 to regulate and control actions for thermal management.

Based on the data representative of the temperatures 420 for the components 416, 418, the thermal system 426 can be actuated to perform one or more of the following actions: transfer the heat generated from one or more components 416, 418 to provide directed heating to one or more of the components 416, 418; transform the heat generated from one or more components 416, 418 into usable energy via, e.g., a thermoelectric generator 428 of the vehicle 402; and/or dissipate the heat generated from one or more components 416, 418 into the environment around the vehicle 402.

The thermal system 426 can be operated in this manner in a variety of scenarios. Transfer of energy for direct heating can be used in, e.g., computing or processing unit to battery, combustion engine to heated trailer, electric motor to sensor(s) (especially in the winter during start-up of the vehicle), or the like. Transforming heat into usable energy can be used in, e.g., computing or processing unit heat via thermoelectric generator into electricity, heat from an electric motor or a combustion engine via a Stirling motor, or the like. Dissipating the heat generated can be used in, e.g., heat generated in battery during loading (electric vehicle) or electric motor via radiator, or the like.

For example, if one of the components 416 requires heating based on the threshold temperature values 424, and one or more components 418 are generating a certain amount of heat 422, the thermal system 426 can be actuated to transfer the generated heat to the component 416 that needs to be heated. The thermal system 426 can be controlled to use various energy pipes and distribution blocks to simultaneously cool certain components (e.g., components 418) and guide the heated cooling fluid to the components (e.g., components 416) that need to be heated, and vice versa.

If heat generated by certain components 416, 418 is not needed to heat other components 416, 418 of the vehicle 402, the thermoelectric generator 428 can be used to transform the generated heat 422 into generated energy 430, which can be stored in a power or energy storage device or system 440 (e.g., a battery, or the like). The stored energy 436 data can be stored in the database 412. In some instances, the thermal system 426 can at least partially dissipate or vent the heat generated by the components 416, 418, and the dissipated heat 434 data can be stored in the database 412.

In some embodiments, the heat generated from the components 416, 418 may not (at least initially) be sufficient to regulate the desired temperatures for the components 416, 418. In such embodiments, the vehicle 402 can include one or more heat sources 438 which can be selectively actuated to generate and supply heat to one or more components 416, 418. In some embodiments, the heat source 438 can be used only during initial stages of operation of the vehicle 402 and, when the components 416, 418 are sufficiently generating heat for distribution by the thermal system 426, the heat source 438 can be shut down until it is needed again.

In some embodiments, the planned route 442 for the vehicle 402 can be used to determine how the thermal system 426 is operated. For example, the planned route 442 can include information regarding, e.g., the travel distance, the terrain, ambient or environment temperatures, combinations thereof, or the like. The environment temperatures can be acquired from external sources and/or from environment sensors 448. In some embodiments, historical data 444 can be used in combination with the planned route 442 to estimate the effect of the planned route 442 characteristics on the components 416, 418 of the vehicle 402.

As an example, if mountainous terrain is expected along the route 442, based on historical data 446, the system 400 can estimate that certain components will generate more heat than if a flat terrain was expected, resulting in more required cooling for such components. If the planned route 442 includes mountainous terrain that may lead to colder environment temperatures, the system 400 can estimate that certain components will require more heating to maintain the nominal or preferred component temperature values 424. Based on these estimates, the system 400 can adjust operation of the thermal system 426 to prepare the components 416, 418 for the upcoming route 442. For example, the thermal system 426 can cool certain components 416, 418 more than normal to ensure the components 416, 418 do not overheat when mountainous terrain is encountered; or can heat certain components 416, 418 more than normal in preparation for a large temperature drop. As a further example, if the route 442 includes an uphill terrain followed by a downhill terrain, the system 400 can expect that initial heat generation by the battery during vehicle travel along the uphill terrain will subsequently be transitioned to battery cooling during the downhill terrain, and no (or little) modification to the system 400 operation is needed. As a further example, if more energy is expected to be needed for a specific terrain along the route 442, the system 400 can conserve energy rather than dissipating the generated heat.

In some embodiments, the system 400 can consider the time of day (e.g., the heat generating or mixed heat source/sinks may necessitate more cooling during the day than at night in desert-like terrain). In some embodiments, the optimization of thermal management can depend on the weight of the load of the vehicle 402, e.g., a greater weight of the load resulting in higher amounts of heat generated. In some embodiments, the information used by the thermal management system 400 can be combined with information from the terrain (e.g., uphill or downhill) and the current/expected load (e.g., mass of the vehicle 402) to optimally design the thermal management system 400. Alternatively, based on the gathered information, the system 400 can decide at which time of the day it is most efficient to drive a certain route.

In some embodiments, based on the capabilities of the thermal system 426 and/or the components 416, 418, distributing heating and/or cooling by the thermal system 426 may not be possible for all components 416, 418. In such embodiments, the system 400 can include weighted values 450 that allow the thermal system 426 to determine which components 416, 418 take priority for heating and/or cooling to ensure the vehicle 402 performance is optimized. For example, the cooling or heating system for the vehicle 402 can be designed such that there is generally always enough cooling or heating capacity for almost any situation. For the rare instances where this is not the case, the thermal management system 400 is programmed with input of the thermal operating ranges of the single components and the criticality of such components falling out of the operating ranges.

In the case of an autonomous vehicle 402, the sensors 408 relevant driving of the vehicle 402 are safety critical and, therefore, are considered by the system 400 as the most relevant (and therefore prioritized with the weighted values). In the case of a non-autonomous electric vehicle, the battery is one of the most costly components to replace and can therefore be prioritized with the weighted values. Further, based on the specifications from the manufacturer and the surrounding conditions, a mathematical model (e.g., a virtual twin) can be used by the system 400 to predict the temperature of the components in the future. Based on the information together with fused data from the terrain, prioritization for heating or cooling can be additionally determined.

The thermal system 426 can be operated in a variety of ways to optimize overall operation of the components 416, 418. For example, the thermal system 426 can control the amount of fluid passing through the heat exchanger to influence/control the level of heating/cooling which one component 416, 418 receives. If the thermal system 426 has two heat generating sources, the thermal system 426 can determine if these components should be maintained separate or if combining them to heat other components 416, 418 is preferred.

The thermal system 426 can weigh the amount of fluid passing through the system to optimize the temperatures of certain components 416, 418 of the vehicle 402. For example, relative to the other system components, if components 416, 418 have the greatest relative operational impact when the components 416, 418 are operating at a lower than required temperature. In such situations, the components 416, 418 would require higher priority heating during operation and as a result, according to the thermal system weighing, can receive the heat distribution first, as compared to secondary or non-essential components. For example, sensors 408 may be able to endure a wider range of temperatures, in some instances, and could be given less priority for cooling/heating as compared to the battery or other more sensitive components 416, 418. In some embodiments, the weighing can occur at the start of the vehicle 402, and heating can be varied gradually once normal operation of the vehicle 402 has been reached and stabilized.

In some embodiments, “normal” operation of the vehicle 402 can be determined by the system 400 in the following ways. The system 400 can be programmed with input of all optimal temperature operation ranges for the relevant components. The system 400 can monitor the temperatures of the components. When all temperatures of the single components stay within a certain margin over an extended period of time (e.g., normalized by terrain information, such as the elevation of the road), the system can determine whether normal operation has been reached. The system 400 can be incorporated with predictive models (e.g., virtual twins) for the single components. In such embodiments, all temperatures in the system 400 and their history (as well as the surrounding conditions, including terrain information) can be known and input into the system 400. Based on this information, the system 400 can safely predict when all components will be within a normal operating range.

A controller (e.g., the processing device 404) can make decisions regarding how distribution of heating should be performed to optimize operation of the components 416, 418 and the vehicle 402. These decisions can be made based on, e.g., importance of the components 416, 418, temperature threshold values for the components 416, 418, or the like. Real-time adjustment of the thermal system 426 operation can be made based on the sensor 408 readings. The system 400 therefore advantageously relies on existing components 416, 418 of the vehicle 402 to optimize heating and/or cooling of the components 416, 418, and even generating energy when possible. Operation of the system 400 optimizes the conditions for the components 416, 418, and provides fuel and energy efficiency for the vehicle 402.

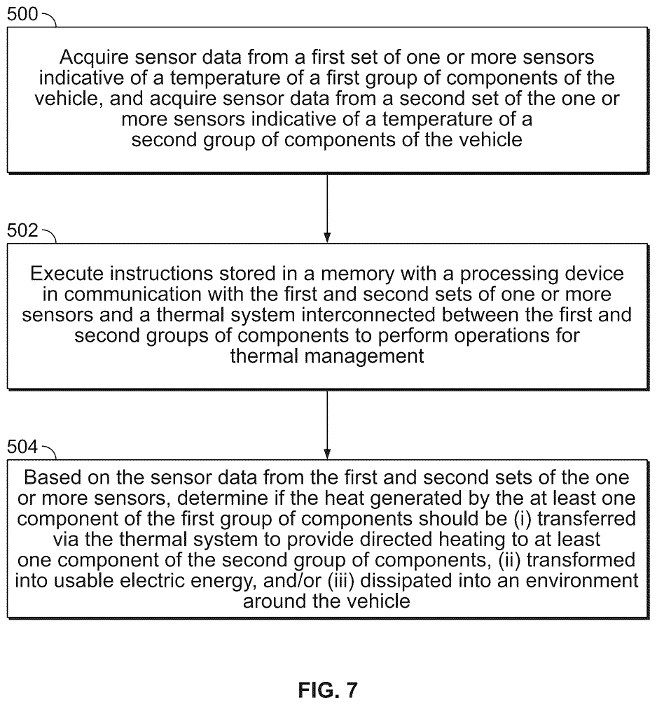

FIG. 7 is a flowchart of a method for thermal management of a vehicle by the exemplary system 400 discussed herein. At 500, sensor data is acquired from a first set of one or more sensors indicative of a temperature of a first group of components of the vehicle, and sensor data is acquired from a second set of one or more sensors indicative of a temperature of a second group of components of the vehicle. At 502, instructions stored in a memory are executed with a processing device in communication with the first and second sets of sensors and a thermal system interconnected between the first and second group of components to perform operations for thermal management. At 504, based on the sensor data from the first and second sets of sensors, it is determined if the heat generated by the at least one component of the first group of components should be transferred via the thermal system to provide directed heating to at least one component of the second group of components, be transformed into usable electric energy, and/or be dissipated into an environment around the vehicle.

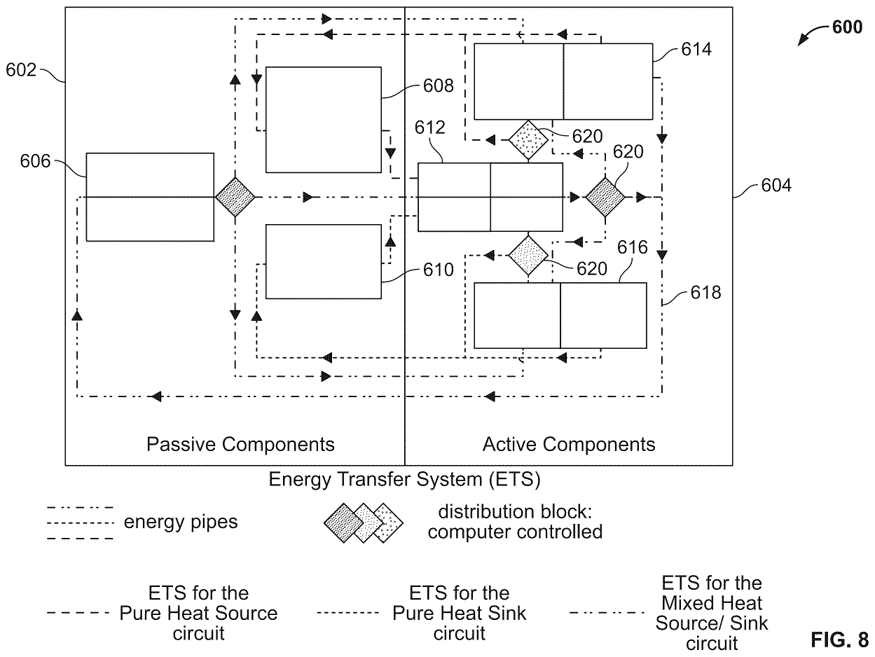

FIG. 8 is a block diagram of an exemplary thermal management system 600 (e.g., system 400) of the present disclosure. The system 600 includes one or more passive components 602 and one or more active components 604. The active and passive components 604, 602 are connected to each other by a network of energy pipes 618 and/or distribution blocks 620, forming a thermal system. The passive components 602 can include, e.g., mixed heat/source sinks 606, pure heat sources 608, pure heat sinks 610, combinations thereof, or the like. The active components 604 can include, e.g., heat exchangers 612, decrease energy components 614, increase energy components 616, combinations thereof, or the like. As shown in FIG. 8, fluid from the pure heat sources 608 and from the pure heat sinks 610 is supplied to the heat exchanger 612. The fluid exiting the heat exchanger 612 is directed to the required components by controlled distribution unit 620. The unit 620 directs the fluid to either or both of the decrease energy components 614 or mixed heat/source sinks 606, and thereby maintains the components 614, 606 at the required operating temperatures.

In some embodiments, the mixed heat source/sinks 606 can include, e.g., a battery pack, sensors, the vehicle cabin (especially for semi-autonomous or non-autonomous vehicles), the trailer (if certain temperatures are to be maintained), or the like. In some embodiments, the pure heat sources 608 can include, e.g., a computing device, a motor, a gearbox, a cooled trailer, an air conditioning unit, or the like. In some embodiments, the pure heat sinks 610 can include, e.g., a heated trailer, or the like. In some embodiments, the decrease energy devices 614 can include, e.g., a thermo-electric generator, a Stirling motor, dissipation devices, or the like. In some embodiments, the increase energy devices 616 can include, e.g., an electric heater, or the like.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A thermal management system for a vehicle, the thermal management system comprising:
a first set of one or more sensors configured to measure at least one of a heat flux or a temperature of a first group of components of the vehicle, at least one component of the first group of components generating heat;
a second set of one or more sensors configured to measure at least one of a heat flux or a temperature of a second group of components of the vehicle;
a thermal system interconnected between the first and the second groups of components; and
a processing device in communication with the first and the second sets of the one or more sensors and the thermal system, wherein the processing device is configured to execute instructions stored in a memory to perform operations comprising:
acquiring sensor data from the first set of the one or more sensors indicative of the heat flux and/or the temperature of the first group of components of the vehicle, and acquiring sensor data from the second set of the one or more sensors indicative of the heat flux and/or the temperature of the second group of components of the vehicle; and
based on the sensor data from the first and second sets of the one or more sensors, determining if the heat generated by the at least one component of the first group of components should be (i) transferred via the thermal system to provide directed heating to at least one component of the second group of components, (ii) transformed into usable electric energy, and/or (iii) dissipated into an environment around the vehicle.

2. The system of claim 1, wherein the vehicle is an autonomous vehicle.

3. The system of claim 1, wherein the vehicle is a semi-autonomous vehicle or a non-autonomous vehicle.

4. The system of claim 1, wherein the first group of components includes pure heat sources.

5. The system of claim 4, wherein the pure heat sources include at least one of a computing device, a motor, a gearbox, or a cooled trailer.

6. The system of claim 1, wherein the first group of components and the second group of components include mixed heat source/sink sources.

7. The system of claim 6, wherein the mixed heat/sink sources include at least one of a battery, a sensor, a vehicle cabin, or a trailer.

8. The system of claim 1, wherein the first group of components includes passive components in the form of a pure heat source, a mixed heat/sink source, and/or a pure heat sink.

9. The system of claim 1, wherein the second group of components includes active components in the form of energy increasing components, energy decreasing components, and/or heat exchanging components.

10. The system of claim 1, comprising a heat source, and the operations comprise selectively generating and supplying heat from the heat source to the first and/or second group of components from the heat source.

11. The system of claim 1, comprising a thermoelectric generator configured to transform the heat generated by the at least one component of the first group of components into the usable electric energy.

12. The system of claim 11, comprising an energy storage configured to store the usable electric energy generated by the thermoelectric generator.

13. The system of claim 1, wherein the operations comprise analyzing a planned route for the vehicle and determining if the heat generated by the at least one component of the first group of components should be (i) transferred via the thermal system to provide the directed heating to at least one component of the second group of components, (ii) transformed into the usable electric energy, and/or (iii) dissipated into the environment around the vehicle, based on the planned route.

14. The system of claim 1, wherein the operations comprise weighing which components of the second group of components necessitate transfer of the heat via the thermal system.

15. The system of claim 1, comprising an environment sensor configured to measure a temperature in the environment around the vehicle.

16. The system of claim 15, wherein the at least one component of the second group is a battery, and the operations comprise transferring via the thermal system the heat generated by the at least one component of the first group of components to warm the battery when the temperature in the environment is measured to be below a threshold value during starting of the vehicle.

17. The system of claim 16, wherein the operations comprise, after a predetermined time after starting of the vehicle, removing the heat generated by the at least one component of the first group of components from the battery.

18. A computer-implemented method for thermal management of a vehicle, the computer-implemented method comprising:
acquiring sensor data from a first set of one or more sensors indicative of at least one of a heat flux or a temperature of a first group of components of the vehicle, and acquiring sensor data from a second set of the one or more sensors indicative of at least one of a heat flux or a temperature of a second group of components of the vehicle; and
executing instructions stored in a memory with a processing device in communication with the first and second sets of the one or more sensors, and a thermal system interconnected between the first and second groups of components, to perform operations comprising:
based on the sensor data from the first and second sets of the one or more sensors, determining if the heat generated by the at least one component of the first group of components should be (i) transferred via the thermal system to provide directed heating to at least one component of the second group of components, (ii) transformed into usable electric energy, and/or (iii) dissipated into an environment around the vehicle.

19. The method of claim 18, wherein the first group of components includes passive components in the form of a pure heat source, a mixed heat/sink source, and/or a pure heat sink.

20. The method of claim 18, wherein the operations comprise selectively generating and supplying heat from the heat source to the first and/or second group of components from a heat source.
